(19) United States
(12) Patent Application Publication
(10) Pub. No.: US 2007/0151400 A1
(43) Pub. Date: Jul. 5, 2007

(54) Brake unit for a walking aid

(75) Inventor: Pao Shan Huang, Chiai Hsien (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/648,690

(22) Filed: Jan. 3, 2007

(30) Foreign Application Priority Data
Jan. 4, 2006 (TW) 095200162

(51) Int. Cl. G05G 5/06

(52) U.S. Cl. 74/532

(57) ABSTRACT

A brake unit for a walking aid includes a user-grippable handle formed with a non-circular opening for retaining by a pin within a holding base. The user-grippable handle has a non-braking position, a preliminary braking position, and a parked braking position. When the walking aid is in a parked braking state, a user can simply lift the user-grippable handle upwards and change the parked braking state into a non-braking state.

### FIELD OF THE INVENTION

The present invention relates to a brake unit for a walking aid, and in particular, to a hand brake unit for a wheeled walking aid which can be operated under a non-braking state, a preliminary braking state and a parked braking state, to provide the user with a convenient and safe manner of control.

### DESCRIPTION OF THE RELATED ART

There is an increased demand for products which aid an aged person in outdoor walking, such as walking aid products. Such walking aid can support and assist an aged person in walking alone.

A conventional walking aid is commonly provided for a user to move and can be supported by both hands, similarly to using a cane. A wheeled frame structure of a conventional walking aid provides the user with a brake unit to slow or stop to help avoid accidents or dangerous sliding from high speed on a slope.

As aged person can take actions more slowly, and require the walking aid for safety and convenience. A related structure is disclosed in Japanese Patent 11-089899, which has a holding device for holding a brake control bar in position when braking a wheeled walking aid. While recovering from brake status, the user should release the brake control bar by pulling the holding device. This is inconvenient, as the user needs to release the brake control bar by rotating the holding device. It is therefore necessary to use one hand to pull the brake control bar against the handle, so as to force the holding device to depart slightly from the holding device, and then bend the holding device to the left to turn the brake control bar. Basically, the manipulation of the structure of Japanese Patent 11-089899 always requires an aged person to use both hands to control the brake, which is inconvenient.

### SUMMARY OF THE INVENTION

In order to simplify the manipulation and structure of the related art, the present invention provides a solution for a brake unit of a walking aid. The walking aid comprises a wheeled frame which has a cable controllable brake device equipped with a stopper on each wheel. When the brake device is pulled by the cable, the stopper will cause the wheel to be braked.

The brake unit of the present invention comprises a user-grippable handle and a holding base. The holding base is connected with the wheeled frame and comprises a connecting housing, a positioning element and a receiving space.

The user-grippable handle has one end formed with a retaining opening, an extension arm, and a cable connecting portion. The control end of the user-grippable handle is retained by a pin which penetrates the retaining opening within the receiving space

In a non-braking state, the cable pulls the user-grippable handle against the positioning element and maintains the user-grippable handle in a non-braking position.

In a preliminary braking state, the user-grippable handle is held upwards by the palm of the user to slow the velocity of the walking aid.

In a parked braking state, the extension arm of the user-grippable handle abuts the positioning element, so as to keep the user-grippable handle downward and pull the cable to brake the wheel of the walking aid.

This is convenient for users, as when the walking aid 10 is in a parked braking state, the user-grippable handle 5 simply needs to be lifted upwards in order to change the walking aid 10 from the parked braking state into a non-braking state.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention.

FIG. 1 is a perspective view of the present invention connected with a wheeled walking aid.

FIG. 2 is an exploded view of an embodiment of the brake unit according to the present invention.

FIG. 3 is a schematic view showing the brake unit in a non-braking state.

FIG. 4 is a schematic view showing the brake unit in a preliminary braking state for slowing velocity.

FIG. 5 is a schematic view showing the brake unit in a parked state.

### DETAILED DESCRIPTION OF THE PREFERRED EMBODIMENTS

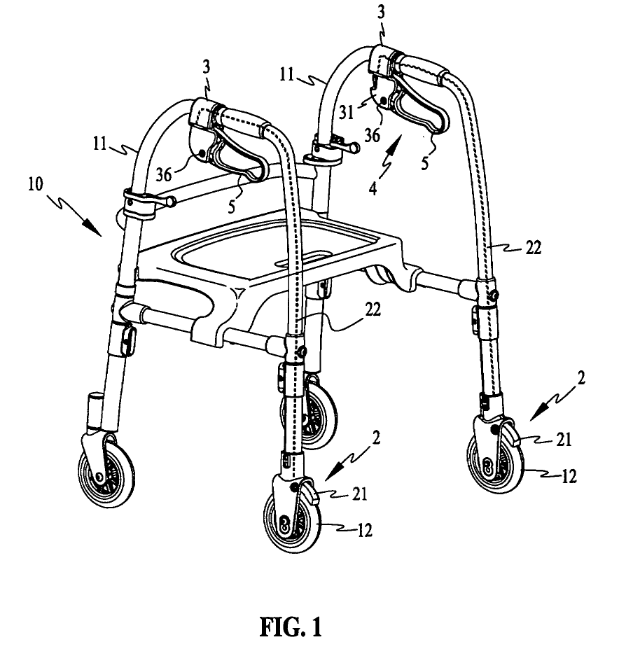

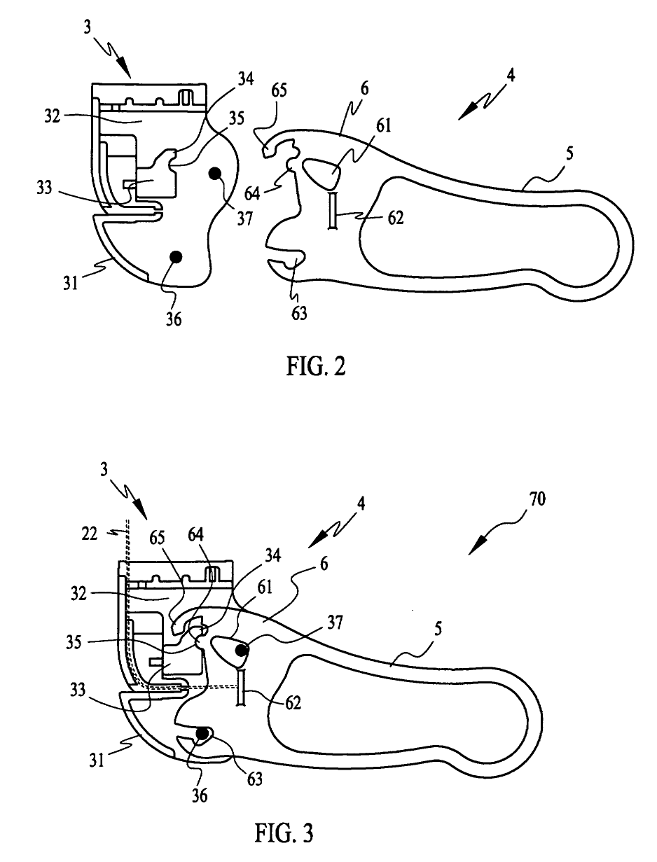

Referring to FIGS. 1 and 2, the present invention has a brake unit 4 for a walking aid 10. The walking aid 10 comprises a wheeled frame 11 having a cable controllable brake device 2 equipped with a stopper 21 on wheel 12. When the brake device 2 is pulled by the cable 22, the stopper 21 will cause the wheel 12 to brake.

The brake unit 4 of the present invention comprises a user-grippable handle 5 and a holding base 3. The holding base 3 is connected with the wheeled frame 11 and comprises a connecting housing 31 and a positioning element 33, and is formed with a receiving space 32.

The user-grippable handle 5 has one control end 6 formed with a non-circular retaining opening 61, an extension arm 65 and a cable connecting portion 62 for connecting with the cable 22. The control end 6 of the user-grippable handle 5 is movably and rotatably retained by a first pin 37 which is penetrates and is fixed within the non-circular retaining opening 61 in the receiving space 32.

Referring again to FIG. 1, the brake device 2 has a resilient element (not shown) for keeping the stopper 21 in its non-brake position. The force from said resilient element always causes the control end 6 of the user-grippable handle 5 to pull against the cable 22.

Referring to FIG. 3, in a non-braking state 70, the cable 22 pulls the user-grippable handle 5, so as to press against the positioning element 33. This keeps the user-grippable handle 5 in a non-braking position. Preferably, to increase mechanical stability, the positioning element 33 may be further formed with an indent 35, and the control end 6 can be formed with a protrusion 64 for resting on the indent 35.

The connecting housing 31 may also comprise a second pin 36 within the receiving space 32, and the control end 6 of the user-grippable handle 5 may further be formed with a slot 63 for receiving the second pin 36. In the described non-braking position, the second pin 36 is received against the very bottom of the slot 63 and helps stop the user-grippable handle 70 from further downward rotation

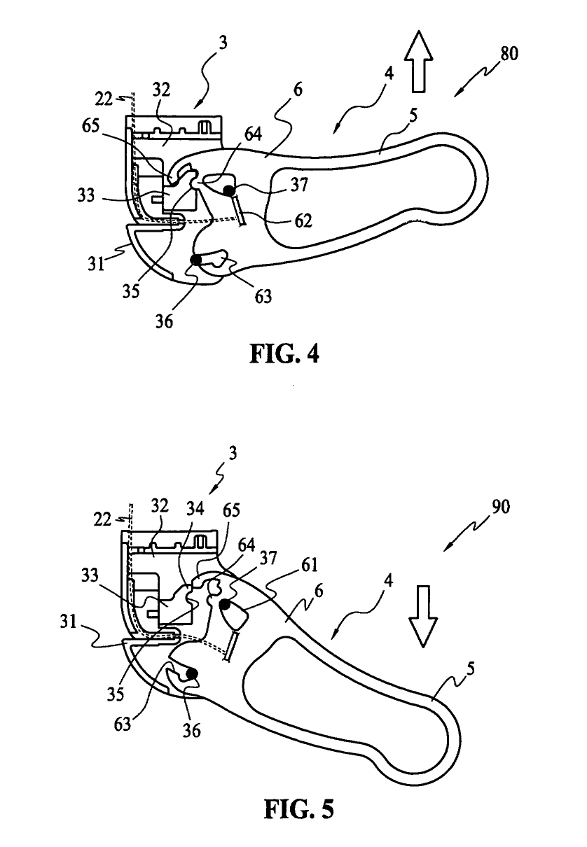

Referring to FIG. 4, in a preliminary braking state 80, the user-grippable handle 5 can be held upwards by the palm of the user. This would pull the cable 22 to actuate the brake device 2 and slow the velocity of the walking aid 10. In this configuration, the second pin 36 is free to-travel along the slot 63.

Referring to FIG. 5, in a parked braking state 90, the extension arm 65 of the user-grippable handle 90 abuts against the positioning element 33, so as to keep the user-grippable handle 5 at a fixed angle. This pulls the cable 22 and brakes the wheel 12 of the walking aid 10. In this configuration, the user-grippable handle 5 is rotated about the second pin 36, which is abutted against the bottom of the slot 63.

The extension arm 65 may rest on the indent 35 to keep the user-grippable handle 90 at a fixed angle. However, the positioning element 33 may be further formed with another recess (not shown) or a protruded abutment portion 34, as shown in FIG. 5, for the extension arm 65 to rest thereupon.

While the invention has been described by way of example and in terms of preferred embodiments, it is to be understood that the invention is not limited thereto. On the contrary, it is intended to cover various modifications and similar arrangements and procedures, and the scope of the appended claims therefore should be corded the broadest interpretation so as to encompass all such modifications and similar arrangements and procedures.

1. A brake unit for a walking aid, comprising:
a holding base connected with a wheeled frame, the holding base having a connecting housing formed with a receiving space and equipped with a positioning element and a first pin; and
a user-grippable handle, having a control end received within the receiving space, the control end being formed with a non-circular retaining opening and a connecting portion for connecting with a cable of a brake device.

2. The brake unit of claim 1, wherein the first pin of the holding base penetrates through the non-circular retaining opening for retaining the control end within the receiving space.

3. The brake unit of claim 1, wherein the control end of the user-grippable handle is formed with an extension arm for abutting against the positioning element by when the cable of the brake device is pulled.

4. The brake unit of claim 1, wherein the positioning element is formed with an indent on which the control end of the user-grippable handle rests when the cable of the brake device is pulled.

5. The brake unit of claim 1, wherein the control end of the user-grippable handle is formed with a protrusion for contact with the positioning element when the cable of the brake device is pulled.

6. The brake unit of claim 1, wherein the control end of the user-grippable handle is formed with a protrusion and an extension arm for contact with the positioning element when the cable of the brake device is pulled.

7. A brake wit for a walking aid, comprising:
a holding base connected with a wheeled frame of a walking aid, the holding base having a connecting housing formed with a receiving space and equipped with a positioning element, a first pin and a second pin; and
a user-grippable handle having a control end received within the receiving space, the control end being formed with a non-circular retaining opening, a slot for movably receiving the second pin of the holding base, and a connecting portion for connecting with a cable of a brake device.

8. The brake unit of claim 7, wherein the first pin of the holding base penetrates the non-circular retaining opening for retaining the control end within the receiving space.

9. The brake unit of claim 7, wherein the control end of the user-grippable handle is formed with an extension arm for abutting against the position element by when the cable of the brake device is pulled.

10. The brake unit of claim 7, wherein the position element is formed with an indent for the control end on which the user-grippable handle rests when the cable of the brake device is pulled.

11. The brake unit of claim 7, therein the control end of the user-grippable handle is formed with a protrusion for contact with the positioning element when the cable of the brake device is pulled.

12. The brake unit of claim 7, wherein the control end of the user-grippable handle is formed with a protrusion and an extension arm for contact with the positioning element when the cable of the brake device is pulled.
